(19) United States
(12) Patent Application Publication
(10) Pub. No.: US 2005/0045006 A1
(43) Pub. Date: Mar. 3, 2005

(54) Compact web severing device

(76) Inventors: Randall A. Addington, Melbourne, FL (US); Eduardo Morales, McAllen, TX (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(21) Appl. No.: 10/790,985

(22) Filed: Mar. 2, 2004

Related U.S. Application Data
(60) Provisional application No. 60/451,694, filed on Mar. 4, 2003.

(51) Int. Cl. B26B 3/00

(52) U.S. Cl. 83/13; 30/2; 30/289

(57) ABSTRACT

A cutting tool for severing a paper ribbon label that covers and attaches a lid to the outer sidewall of a cylindrical container, as may be used for the storage of particulate matter, such as tobacco. The cutting tool including a generally arcuate-shaped top portion and a curvilinear band portion extending therefrom, so as to generally conform with and readily placable against the lid of the container. The band portion includes a web-severing cord-edge that is shaped and sized to penetrate through and thereby sever the paper ribbon label, as the tool is rotated around the container lid.

### CROSS-REFERENCE TO RELATED APPLICATION

The present application claims the benefit of co-pending Provisional Patent Application, Ser. No. 60/451,694, filed Mar. 4, 2003, entitled: “Compact Web Severing Device,” by R. Addington et al, assigned to the assignee of the present application and the disclosure which is incorporated herein.

### FIELD OF THE INVENTION

The present invention relates in general to container opening devices, and is particularly directed to a compact cutting tool for severing the paper label or relatively thin webbing layer that covers and attaches a lid to the outer sidewall of a cylindrical container used for the storage of particulate matter, such as tobacco.

### BACKGROUND OF THE INVENTION

Containers used for the storage of particulate or granulated material come in a variety of shapes and sizes. Those used for the storage of particulate tobacco are customarily of the same shape and size, being configured as relatively shallow cylindrical containers, as diagrammatically illustrated in FIG. 1. As further shown in the partial side view of FIG. 2, the container 1 is formed of a generally cylindrical tube 10, which is typically made of a material such as rigid cardboard and the like. Opposite open circular ends 12 and 14 of the cylindrical tube 10 are closed by respective cylindrical lids 20 and 30, whose interior diameters are sized to snugly fit over respective end portions 16 and 18 of the outer cylindrical sidewall of the tube 10. In order to effectively close and seal the container 1, a generally flat ribbon 40 of webbing material, such as paper and the like, is wrapped around the outer cylindrical sidewalls 22 and 32 of lids 20 and 30, respectively. The ribbon 40 is securely sealed with the lids by means of associated adhesive layers 24 and 34.

Because the outer diameter of the cylindrical tube 10 is less than the outer diameter of the lids 20 and 30, a generally annular space 50 is formed between the central portion 45 of the ribbon 40 and the central portion 15 of the tube 10, which is not covered by the lids 20 and 30. This annular space allows the user to sever the paper ribbon 40 (usually by pressing and dragging the edge of a fingernail against the paper wrapping 40), so that one of the lids may be removed and thereby open the container. Through continued use for this purpose, however, the user's fingernails eventually may become worn down to such an extent that it becomes difficult to open the container in this manner. Thus, there is a need for a tool for the purpose.

### SUMMARY OF THE INVENTION

In accordance with the present invention, this objective is successfully achieved by means of a generally compact cutting tool, that is configured to conform with and be readily placed against the lid portion of the generally cylindrical container of the type described above. The tool contains a web-severing edge that is shaped and sized to readily pierce the paper ribbon at the central portion of the tube, so as to facilitate opening the container, without the user having to use a fingernail.

As will be detailed below, the cutting tool of the present invention may be made of a relatively rigid material, such as metal, hard plastic, and the like. The cutting tool has a generally arcuate-shaped top portion, having a generally curvilinear outer edge portion. Extending generally orthogonal or perpendicular to this out edge portion is a generally a curvilinear or cylindrically shaped band segment. The arcuate-shaped top portion and the cylindrically shaped band segment are sized to be placed and generally ‘fit’ against the container to be opened. When so placed, the top portion of the tool is allowed to rest against one of the closure lids of the container, while the band segment of the tool engages the outer cylindrical sidewall of the one closure lid.

In order to sever the material of the sealing ribbon, the tool further includes a generally cord-shaped cutting edge that extends along the interior surface of the band segment so as to be parallel to the top portion of the tool. For purposes of tool handling safety, the cutting edge is preferably configured as a semi-dull edge, in that the edge is sufficiently sharp to penetrate through. the paper webbing when urged against and across its surface, but is generally insufficiently sharp to cut human skin. In order to align the cutting edge with the central portion of the container tube where the ribbon may be severed, and to provide for tool stability in the course of its use, the tool's cutting edge is spaced from the top portion of the tool by a distance, that effectively places the cutting edge immediately adjacent to one of the container's closure lids at the central portion of the container, when the top portion of the tool is placed against the lid, so that the top portion of the tool serves as a guide, while the band segment of the tool is located adjacent to the outer cylindrical sidewall of the lid. The spacing of the cutting edge from the top portion of the tool may be fixed, or may be variable to accommodate different container sizes.

In the container-engaging position of the tool, the cutting edge is located relative to the top of the tool, so that it may be readily brought to bear against that segment of the central portion of the ribbon covering the annular space that is proximate to the edge of a lid. As a result, a generally circular, sliding or twisting motion of the tool around the cylindrical sidewall of the container, as by means of a tab element provided at the top portion of the tool, will cause the tool's cutting edge to traverse a generally circular, ribbon-severing path through the central portion of the ribbon. This in turn causes the tool edge to cut through the ribbon and penetrate into the annular space between the respective end portions of the container, thereby severing or subdividing the ribbon into upper and lower segments. With the ribbon severed at the annular space of the container, the user may readily remove the top lid and gain access to the contents of the container. The tab element may be provided with an aperture to facilitate portability as by attachment to a key ring and the like.

### BRIEF DESCRIPTION OF THE DRAWINGS

FIG. 1 is a diagrammatic perspective view of a generally cylindrical container used for the storage of particulate material;

FIG. 2 is a partial side view of the container of FIG. 1;

FIGS. 3 and 4 are perspective views of the cutting tool of the invention;

FIG. 5 is a plan view of the cutting tool of the invention;

FIG. 6 is a partial side view of the cutting tool of the invention; and

FIG. 7 is a further partial side view of the cutting tool of the invention, wherein the position of the cutting edge is variable relative to the top of the tool.

### DETAILED DESCRIPTION

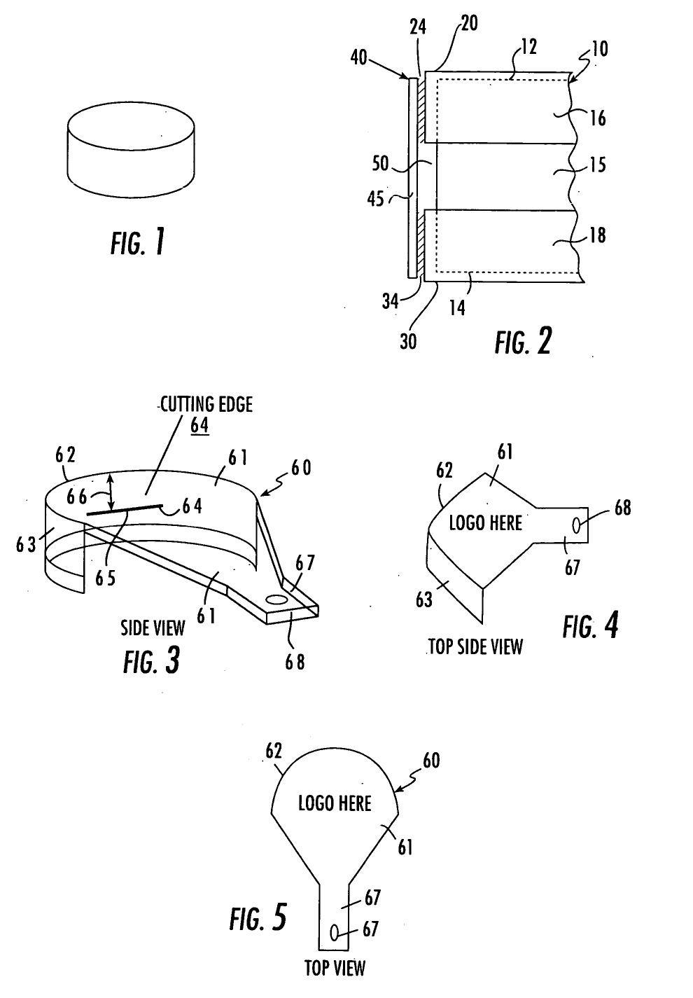

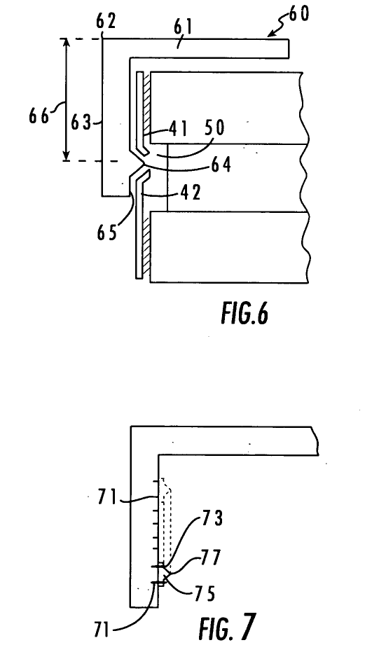

A webbing layer cutting tool that is configured to conform with and be readily placed against the lid portion of a generally cylindrical container in accordance with the present invention is shown diagrammatically in detail in the perspective views of FIGS. 3 and 4, the plan view of FIG. 5, and the partial side views of FIGS. 6 and 7. As described briefly above, the tool according to the present invention contains a web-severing edge that is shaped and sized to readily pierce the paper ribbon at the central portion of the container, so as to facilitate opening the container, without the user having to use a fingernail.

To this end, as diagrammatically illustrated in FIGS. 3-7, the cutting tool 60 of the present invention has a generally arcuate-shaped top portion 61 that terminates at an outer edge portion 62. The tool itself is preferably made of a generally rigid material, such as metal, hard plastic, and the like. Extending perpendicularly a prescribed depth from the outer edge 62 is a generally curvilinear or cylindrically shaped band segment 63. As explained above, and as can be seen from the partial side view of FIG. 6, the arcuate-shaped top portion 61 and the cylindrically shaped band segment 63 are sized to be placed against and generally ‘fit’ against the container to be opened, such that the top portion 61 may rest against one of the closure lids 20, 30 of the container while the band segment 63 of the tool engages the outer cylindrical sidewall of that same one closure lid.

A generally cord-shaped cutting edge 64 extends along the interior surface 65 of the band segment 63 so as to be parallel to the top portion 61 of the tool. For tool handling safety, the cutting edge 64 is preferably configured as a semi-dull edge, that is sufficiently sharp to penetrate through and sever the paper webbing 40 when urged against and across its surface, but is generally insufficiently sharp to cut human skin. In order to align the cutting edge with the central portion 15 of the container tube 10 and provide for tool stability in the course of its use, the cutting edge 64 is spaced from the top portion 61 of the tool by a prescribed distance 66. This prescribed distance 66 is such that it effectively places the cutting edge 64 immediately adjacent to one of the container's closure lids 20, 30 within the central portion 15 of the tube 10, when the top portion 61 of the tool is placed against the lid. This allows the top portion to serve as a guide, while the band segment 63 of the tool is located adjacent to the outer cylindrical sidewall of the container lid.

In this position, shown in the partial side view of FIG. 6, the cutting edge 65 of the tool is readily brought to bear against and severs that segment of the central portion 45 of ribbon 40 covering the annular space 15 that is proximate to the edge of a container lid. As a result, a generally circular, sliding or twisting motion of the tool around the cylindrical sidewall of the container, as by means of a tab element 67 of the top portion 61 of the tool, will cause the tool's cutting edge 64 to traverse a generally circular cutting path through the central portion 45 of the ribbon. (As shown in FIGS. 3, 4 and 5, the tab element 67 may be provided with an aperture 68 to facilitate portability as by attachment to a key ring and the like.) As the tool's cutting edge traverses the generally circular path through the central portion of the ribbon, it cuts through the ribbon 40 and penetrates into the annular space 15, thereby severing or subdividing the ribbon into upper and lower segments 41 and 42. With the ribbon severed at the annular space 15 of the container, the user is readily able to remove the top lid and gain access to the contents of the container.

In the embodiment of the invention shown in FIGS. 3-6, described above, the spacing or separation 66 of the cutting edge 64 from the top portion 61 of the tool is shown as being fixed. In an alternative ‘adjustable’ embodiment, the cutting edge may be configured so that its spacing from the top of the tool may be varied to accommodate different container sizes. To this end, as a non-limiting example, shown in FIG. 7, the band segment 63 of the tool may be provided a set of apertures 71 that are sized to receive fittings 73 such as screws and the like, that are used to anchor a cutting tool element 75 from which a cutting edge 77 projects at a plurality of different spacings from the top portion of the tool. This allows the location of the cutting edge 77 to be adjusted among a plurality of different positions relative to the top portion of the cutting tool, as shown by the dotted lines 79, so that the cutting edge may be, positioned to cut the webbings of differently sized containers.

While we have shown and described an embodiment in accordance with the present invention, it is to be understood that the same is not limited thereto but is susceptible to numerous changes and modifications as known to a person skilled in the art. We therefore do not wish to be limited to the details shown and described herein, but intend to cover all such changes and modifications as are obvious to one of ordinary skill in the art.

1. A cutting tool for severing webbing layer that covers and attaches a lid to the outer sidewall of a cylindrical container of the type used for the storage of particulate matter, said cutting tool comprising a generally arcuate-shaped top portion and a curvilinear band portion extending therefrom, so as to generally conform with and readily placable against said lid of said container, said band portion including a web-severing cutting element that is shaped and sized to penetrate through and sever said webbing layer, as said cutting tool is rotated around said container lid.

2. The cutting tool according to claim 1, wherein said web-severing cutting element comprises a generally cord-configured cutting edge that is generally parallel to said generally arcuate-shaped top portion of said cutting tool.

3. The cutting tool according to claim 2, wherein said generally arcuate-shaped top portion includes a tab portion that is adapted to allow a user of said cutting tool to rotate said cutting tool around said container lid.

4. The cutting tool according to claim 1, wherein vertical spacing between said web-severing cutting element and the top portion of said cutting tool is adjustable.

5. A cutting tool for severing a webbing layer that covers and attaches a container lid to an outer sidewall of a cylindrical container of the type used for the storage of tobacco and the like, said cutting tool comprising a generally arcuate-shaped top portion that terminates at an outer edge portion, a generally curvilinearly shaped band segment extending generally perpendicularly from said outer edge portion of said top portion of said tool, said arcuate-shaped top portion and said band segment being sized to be placed against and generally fit against said container, such that said top portion may rest against said container lid, while said band segment engages said outer cylindrical sidewall of said container lid, a cutting edge that projects from interior surface portion of said band segment so as to be generally parallel to said top portion of said tool, said cutting edge being configured as a semi-dull edge, that is sufficiently sharp to penetrate through and sever said webbing layer when urged against and across its surface, but is generally insufficiently sharp to cut human skin, and wherein said cutting edge is spaced from said top portion of said tool by a prescribed distance that effectively places said cutting edge immediately adjacent to said lid within a generally central annular space portion of said container where said lid does not extend, such that, when said top portion of the tool is placed against said lid, said top portion of said tool acts as a guide and locates said band segment adjacent to said outer cylindrical sidewall of said lid, and allows said cutting edge to be urged against and sever that portion of said webbing material covering said annular space that is proximate to the edge of said container lid.

6. The cutting tool according to claim 5, wherein said cutting edge comprises a generally cord-configured cutting edge.

7. The cutting tool according to claim 6, wherein said generally arcuate-shaped top portion includes a tab portion that is adapted to allow a user of said cutting tool to rotate said cutting tool around said container lid, such that a generally circular, sliding or twisting motion of said tool around the cylindrical sidewall of said container, by means of said tab portion, will cause said cutting edge to traverse a generally circular cutting path through said webbing material, and penetrate into said annular space, thereby severing said webbing layer into upper and lower segments, so that said user may remove said and gain access to the contents of said container.

8. The cutting tool according to claim 5, wherein vertical spacing between said cutting edge and the top portion of said cutting tool is adjustable.

9. A method of severing webbing layer that covers and attaches a lid to the outer sidewall of a cylindrical container of the type used for the storage of particulate tobacco material and the like, comprising the steps of:
(a) providing a cutting tool having a generally arcuate-shaped top portion and a curvilinear band portion extending therefrom, so as to generally conform with and readily placable against said lid of said container, said band portion including a web-severing cutting edge that is shaped and sized to penetrate through and sever said webbing layer, as said cutting tool is rotated around said container lid;
(b) placing said top portion of said tool against said lid, so that said top portion of said tool acts as a guide and locates said band segment adjacent to said outer cylindrical sidewall of said lid, and allows said cutting edge to be urged against and sever that portion of said webbing material covering an annular space that is proximate to the edge of said container lid; and
(c) rotating said tool around said lid so as to cause said cutting edge to sever that portion of said webbing material covering said annular space proximate to the edge of said container lid.

10. The method according to claim 9, wherein said web-severing cutting element comprises a generally cord-configured cutting edge that is generally parallel to said generally arcuate-shaped top portion of said cutting tool.

11. The method according to claim 10, wherein said generally arcuate-shaped top portion includes a tab portion that is adapted to allow a user of said cutting tool to rotate said cutting tool around said container lid during execution of step (c).

12. The method according to claim 9, wherein vertical spacing between said cutting edge and the top portion of said cutting tool is adjustable.
